(19) United States
(12) Patent Application Publication
(10) Pub. No.: US 2009/0037286 A1
(43) Pub. Date: Feb. 5, 2009

(54) Restaurant patron payment system and method for mobile devices

(75) Inventor: Brian Edward Foster, Ashby, MA (US)

Correspondence Address: FOSTERED SOLUTIONS, INC., 735 MASON ROAD, ASHBY, MA, 01431, US

(73) Assignee: FOSTERED SOLUTIONS, INC., Ashby, MA (US)

(21) Appl. No.: 11/833,423

(22) Filed: Aug. 3, 2007

(51) Int. Cl. G06Q 20/00

(52) U.S. Cl. 705/21; 705/15; 705/16

(57) ABSTRACT

A secure and efficient system and method that allows restaurant patrons to combine, split and/or pay for one or more components of an outstanding bill via a mobile computing device. In the most ideal embodiment, the restaurant has an existing order management/Point of Sale (POS) system installed on a computer network with wireless (Wi-Fi or Bluetooth) capabilities. When patrons have finished eating and are ready to pay for their bill, all outstanding check details are downloaded from a POS database to a mobile computing device over the wireless network. Each patron reviews the check details (listed in an orderly fashion on the screen of the mobile device) to determine how much they each want to pay. Patrons can pay for all or specific parts of the entire bill as well as all or specific parts of each item that was ordered. After a specific payment amount has been identified, each patron can manually enter their card details, swipe a bank card through a magnetic card reader attached to the mobile device or they can choose to have the waitperson pick up a specific amount of cash. The use of smart cards can be used for incentive programs or other related processes. If communicated over a wireless network, bank card transaction details can be sent to the server of the restaurant and can be processed by a 3rd party credit agency of choice.

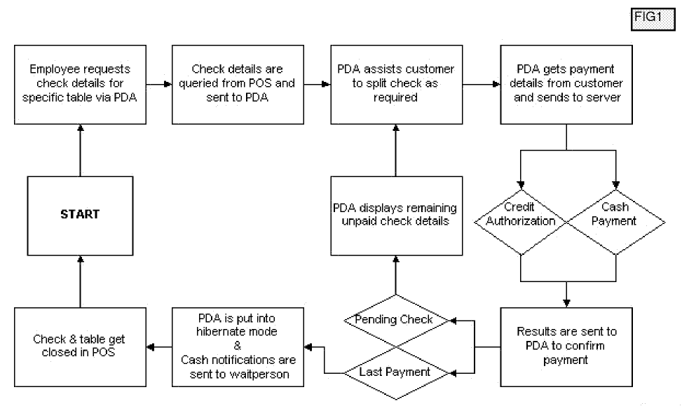

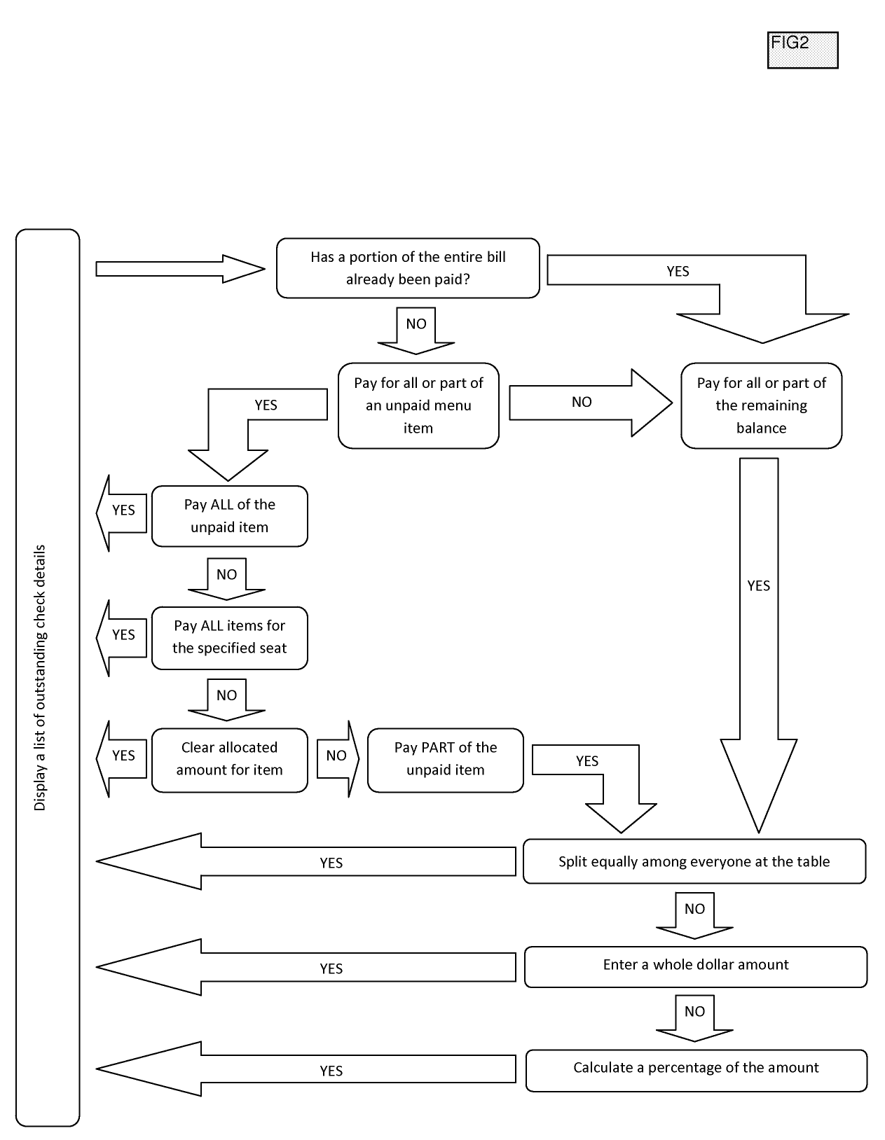

### BACKGROUND

A common request by restaurant patrons dining within a party of two or more people is to have the final outstanding bill split. Although this is a convenience for each patron, it presents specific and undesirable disadvantages to the waitperson and restaurant. Even if the existing ordering/Point of Sale (POS) system has the ability to accomplish such a request, the task of a waitperson to determine what portions of the bill each patron is supposed to pay for can be tedious and very time consuming. This time can cause a reduction in the total number of tables that are turned over as well as reduce the amount of time spent on service to other customers thus decreasing the level of service in the restaurant. For these reasons alone, the request to split a bill is often rejected or limited.

Repercussions of not providing this service may be a consumer's decision not to frequent a restaurant and instead go to an establishment that offers the service to split a bill. A shortage of large parties can be a significant loss of revenue for a restaurant.

Although some POS systems offer methods for a waitperson to split an outstanding bill, the payment details must be managed by its own proprietary software and/or hardware. This presents challenges to restaurants that prefer the non-payment features of their current system but would like to offer their customers more options to pay for their outstanding bill.

### PRIOR ART

U.S. Pat. No. 6,088,681 issued to Coleman, Davis & Morgan is related prior art that tries to aid restaurant staff in the task of splitting a patrons bill. Although such prior art provides a method to allocate portions of a check to an individual bill, it requires the waitperson to remember exactly what each patron desires to pay for. This can prove to be more difficult with large parties that require multiple bills as well as with various patrons that may want to pay for specific portions of another patron's meal. Such prior art also requires that the waitperson deliver each individual bill to the patrons and then process the final payment via a terminal located some distance away from the table. Further delays may be encountered if the waitperson did not split the check in the manner the patron desired, thus requiring the waitperson to re-attempt the previous steps. Additional shortcomings of such prior art relate to each patron having to manually calculate the gratuity based on the bill presented to them.

Another example of related prior art, U.S. Pat. No. 5,933,812 assigned to Verifone, Inc., provides a mobile solution to restaurants. Such prior art provides a restaurant with the ability to let a patron partially process payment for a check at the convenience of their table. Shortcomings with this prior art is that it does not display the details of the check (just a total amount) and it does not provide the patron with the ability to customize their payment amount. Instead, a single payment is made for the entire amount, as determined by the waitperson. Also, a technological disadvantage exists because the system is not operable on a wireless network. Workflow inefficiencies remain because the waitperson must still retrieve the mobile device from the table to upload the payment details to a transaction terminal (some distance away) for final processing. Another shortcoming of the system is that specific (proprietary) hardware and software is required, thus greatly increasing the total cost of investment to the restaurant employing such technology.

U.S. Pat. Application No. 20060283935 with serial number 435395, issued to Scott Peter Henry & Robert Harold Johnson is related prior art that allows patrons to pay for their bill over a wireless network with custom mobile devices. In addition to payment processing, as stated in claim 7 of such prior art, it also provides for an order management process. More specifically, such prior art can be used as an efficient means to provide restaurant patrons the ability to review specific items that were ordered and to make payments on a mobile device but does not allow the user to mathematically combine or split each component of the outstanding bill. Although efficiencies are created by the elimination of tasks normally performed by the waitperson, the prior art does not provide for the ability to calculate & identify for payment, specific portions of each item that was ordered. Also, as with other such prior art, it requires specific (proprietary) hardware and order management software to work in conjunction with each mobile device.

### SUMMARY

A restaurants ability to allow patrons to efficiently split their bill avoids the arduous and often awkward or embarrassing task of each patron trying to manually calculate what they owe from a printed (or handwritten) bill that may be difficult to understand. The present invention allows each patron to use a mobile device to determine exactly how much they need to contribute to the total outstanding bill. The present invention is also beneficial to business patrons that require a receipt stating only their portion of the bill and exactly what they paid for.

By working in conjunction with the existing (or anticipated) technology used within a restaurant, the present invention creates an affordable solution that can be used in a variety of environments. By reducing the financial burden of such an investment in technology and providing additional payment options to the end user (restaurant patrons), the present invention provides a novel and commercially viable utility to the restaurant industry.

The present invention allows each patron within a dining party to identify specific portions of a check that they want to pay for. This novelty allows large parties in a restaurant to be serviced in a much more efficient and desirable manner. In one embodiment, the present invention also allows the customer to make a payment by a bank card or smart card technology, all at the convenience of their own seat, without undue assistance by a waitperson. In yet another embodiment, the present invention can be used in conjunction with incentive programs that reward customer purchases with points that can be used at participating establishments.

The typical operations of a restaurant are only slightly altered to implement the present invention. The task by a waitperson to print an outstanding check for a party that is ready to pay is replaced with the execution of a function within the present invention that automatically downloads the check details for a specific table to a mobile computing device. The mobile computing device is then given to the patron at the table to start the payment process for the related party. In yet another embodiment, the patron may already have a suitable mobile device present (i.e. mobile phone or personal PDA) and can download the check details to their own device.

### PREFERRED EMBODIMENT

In one embodiment, the mobile computing device may be a Personal Digital Assistant (PDA) or Cellular Phone that communicates over a cellular network and or a Bluetooth or Wi-Fi wireless network; After each patron identifies how much they want to pay from the outstanding bill, their bank card payments can be processed real time (immediately) on the PDA without assistance from the waitperson. Regardless of the communication method, after the check has been fully allocated by the patrons, the amount and details of each bank card transaction will be available for processing and any associated cash can be provided to the waitperson. The check can then be identified as being paid in full and receipts can be printed for each payment.

An example of how the present invention can be used is as follows; A party of 10 people is seated at a restaurant that has implemented the present invention. After the party has been served, is finished eating and is ready to pay, they communicate to the waitperson that they are ready to pay for the bill. The waitperson will then obtain one of the PDA devices for use by the system, identify what table is ready to pay and have the check details for that table downloaded to the PDA. The waitperson then brings the PDA device to the table for each patron to review and identify how much they want to pay. As each patron reviews the check details on the screen of the PDA, they can see the cost of each item, the cost of all items ordered by them, as well as the cost of the entire check. In this example, everyone in the party has agreed to pay for equal parts of the entire check, so they will choose the option to “Split the Bill equally among everyone”. This option will calculate their payment by dividing the total of the check by the number of their choice.

Another more complicated example is initiated by the same process as described in the previous example; we'll say that the party is instead dining in celebration of someone's birthday. Due to the special circumstances, everyone in the party has agreed to pay for their own meals as well as an equal portion of the birthday boy's (“Bob”) meal. As it may have it, there also happens to be a few married couples that want to combine the cost of their meals into one payment. After reviewing the check details, each patron will select an item they ordered and choose the option to pay for all the items ordered by their designated seat (married couples will do this for themselves as well as their spouse). Then, each patron will choose to pay for 10% of each item ordered by “Bob”, the birthday boy (married couples will pay for 20% of Bob's meal—10% from each spouse).

For both the above examples, each patron would complete their payment by identifying any gratuity they would like to include (calculations are accomplished by the PDA) as well as how they want to pay (cash, bank card, etc). If a bank card is being used, they will be asked to swipe the card or manually enter their card details, if they are using reward points or a coupon to pay (from an incentive program or advertisement), they can identify any related membership/promotion details (smart card, magnetic card, etc). Once the check has been paid in full, (after all patrons make their payment) the waitperson can be automatically notified to come retrieve any cash payments. Receipts and any change from the cash payments can then be given to the patrons by the waitperson or printed directly from the device.

### ADDITIONAL EMBODIMENTS

In another embodiment, the mobile device may communicate to the server via infrared technology or a USB or serial port located on the docking station of the device; In such an embodiment, the payment amounts identified by each patron is stored by the application (on the mobile device) and later uploaded & processed by the waitperson.

In yet another embodiment, the patron may already own and have in their possession, a cellular phone or personal computing device that can communicate over a cellular, Wi-Fi or Bluetooth network. In this case, the order details could be downloaded to their own device after providing secure login details that are provided by the restaurant.

### DETAILED DESCRIPTION

The present invention requires a computer network and operating system that has a prior art order management/POS system installed on it. A combination of one or more Personal Digital Assistants (PDA), tablet PC's, mobile/smart phones or other storage & communication devices can be used as mobile computing devices. Such devices may be supplied by the restaurant or can be the property of the restaurant patron. In a wireless (Wi-Fi or Bluetooth) environment, at least one wireless router/access point is required to provide communication between the mobile computing devices and the server. Any method of payment that is compatible with the related device/configuration can be used as authorized by the restaurant (i.e. Credit/ATM cards, Smart Cards, biometrics, internet payments, etc).

The present invention is comprised of two software applications, one that resides on the network server of a restaurant and the other residing on one or more mobile computing devices. In one embodiment, communication between a mobile device and the server is over a wireless network, but such communication can also be accomplished by use of infrared technology, a portable media storage card or by a physical USB/serial connection via a docking station suitable for the mobile device being used. Application interfaces (custom programs) are used by the present invention to query and update any related data sources (databases, files, etc) to create a seamless integration with the existing (or anticipated) software and hardware within the restaurant.

The application residing on the mobile computing device provides functionality to the staff as well as the patrons of the restaurant. Check details for a specific table can be downloaded from the server and general administrative functions, that only the restaurant staff have access to, can be accomplished as well. Functions that are intended for use by the patrons can also be performed by the restaurant staff if so desired. Such functions include; displaying instructions relating to a specific Graphical User Interface, sending a request for help to the restaurant staff, determining the cost of a particular item, determining the cost of all items ordered by a particular patron, calculating a percentage of an aforementioned value, calculating/creating a personalized payment amount by adding aforementioned amounts to a final payment amount, calculating a specific gratuity amount or a gratuity amount based on a percentage of the personalized payment, identification and processing for a specific method of payment (bank card, cash, etc) and displaying a summary of all payments made against the check.

The application residing on the server provides functionality to the restaurant staff via Graphic User Interfaces that can be displayed on the screen of an existing restaurant order management/POS system. The application provides the user with the ability to print receipts for payments that have been processed through the aforementioned system. It also provides the ability to confirm and process transaction details for specific payments made against an outstanding check. Specific system options such as method of communication, data source locations & names, record keeping options and network details are also available. Specific preferences such as the formatting of receipts and rules for payment notifications can also be maintained. Specific queries can be executed to produce a report or data export to efficiently and accurately audit historical transactions that have been processed within the aforementioned system.

Any restaurant that uses the system will have a unique site code that is used in conjunction with a number that is assigned to a physical ID (i.e. a magnetic strip card, RFID tag, etc). The manager of the restaurant will be given any number of cards they desire so that each employee can access the secure functions of the system. The primary reason for this is to prevent patrons from accessing the restaurants order management/POS system. Only an employee with access to one of the cards will be able to retrieve check details from the system. Since the distribution of these cards are at the discretion of the manager, the check details of each table will only be available to those authorized to use the system (those which have been given a card). A secondary (optional) use for this is to enhance customer service. The application on the mobile device has the ability to store employee names for each card thus providing a level of customized name recognition. This will enable the patron to see the name of the waitperson that is servicing them. If at any time, a card is lost or stolen, it can be removed from the records on the mobile device so that it will not provide access to the system anymore. Cards from an existing POS system could also be used as well.

The wait staff employees of a restaurant also have the ability to get version details of the application, display general user instructions and to change into a debug mode for troubleshooting system problems.

If employee names have been stored for each card as described earlier, the employee that was last logged in will be displayed for reference. If names are not being used, “General User” will be displayed instead. After the employee swipes an authorized card, the querying process begins.

The first step in the process is for an authorized user to retrieve ordering and payment information for a specific table. Five modes of communication are available for the user to identify, “Infrared”, “Physical” (i.e. serial/USB), “Wi-Fi”, Bluetooth or Cellular. One of the options can be selected by toggle options within the menu. Aside from a backup means of communication, these options also provide restaurants with alternatives to customize the system by allowing them to simply utilize each mobile device as a reference-only tool (giving each patron the ability to split their bill but not pay for it at the table). Another alternative is if the restaurant simply does not want to incur the cost of a wireless network. Instead, they would either manually process the transactions or use infrared, physical or cellular connections. This would not be a “straight-through”, real-time processing environment but provides a less expensive solution to the restaurant.

After identifying a table number, the waitperson will then activate the PAYMENTS function. If the table exists and has an unpaid check recorded in the database of the existing order management system, the details of the check are gathered from the database and transmitted back to the mobile device that requested it.

After the mobile device receives menu descriptions, prices and patron details for each item on the check for the specified table, the details of each item that has been ordered are listed in an orderly fashion. After all the details are displayed to the screen of the device, the waitperson can bring the mobile device to the table for each patron to review and make payments.

Each individual item that was ordered is displayed next to the seat number that ordered it. The unpaid balance as well as the unpaid percentage can be displayed for each item. Another embodiment allows the restaurant to display check boxes instead of percentage values.

To pay for specific items or a specific portion of a selected item, the patron can simply touch/select the related item in the list. Touching/selecting a specific item will display another screen for the patron to identify how much they would like to pay. Alternatively, the patron can split the remaining bill in its entirety. The patron can get general instructions for the screen and, in a wireless environment, a “HELP!” function can be used to send a request for a waitperson.

If an authorized employee card is swiped while a check is being processed, the administrators screen is displayed. This is the only way that the processing of a current check can be interrupted (other than resetting the device). This would be a rare circumstance and the only time it would ever be invoked is if the patron runs into a problem while using the device (i.e. data corruption, processing errors, etc.).

If an amount (of an item or the check) is being split equally, then everybody simply chooses the option to divide the original amount by the amount of people seated at the table. If previous (unequal) payments were made, the amount is automatically adjusted at the last payment to make sure the patron doesn't pay more than is left to pay. The patron can enter whole numbers with the on-screen keypad or via the build-in or on-screen keypad (if available) and the amount is continuously validated to ensure they are not trying to pay more than is left to pay. If they enter more than is left to pay, the amount is adjusted to the remaining unpaid balance.

The patron can choose to “START OVER” at any time to reset their payment amount back to the total unpaid balance. If the patron starts over, they can either pay the bill in full or start the customization process over again.

When a patron chooses the option to pay for part of a specific item, various reference amounts such as the cost of the item and the total bill for the related seat are displayed on the device to provide them with some information to choose an option they most prefer.

When the patron is happy with the amount to be paid (displayed on the screen) they can proceed to identify some final payment details.

The patron can include a gratuity with their payment by selecting a specific percentage of their payment or they can enter a whole dollar amount. If they enter a gratuity that is more than a specified tolerance (i.e. say 50% of their payment), they are asked to confirm the amount. After entering the desired gratuity, the final payment details (gratuity, tax, total, etc) are displayed for the patron to confirm.

If a cash payment is being made, the waitperson can be notified to come get the cash after everyone has paid. If a bank card is being used, the patron is asked to swipe their card or manually enter the card details for authorization. The card details are then sent to the restaurants main server and authorized by a credit processing agency. If the card is successfully authorized, the patron's bank card is debited and the payment is processed on the aforementioned system. If the authorization fails, the patron has the choice to try again or change their method of payment.

After each payment is processed, the new unpaid balances and percentages (or check boxes) are displayed so the next patron can make another payment against the check. After the last payment has been processed (i.e. when the payment amount equals the unpaid balance), the restaurants POS system can be updated to identify that the selected check has been paid.

The most efficient way to utilize the full potential of the present invention is via a real-time processing environment by utilizing a secure wireless (Cellular, Wi-Fi or Bluetooth) network to send the payment details to the existing restaurants POS system. Other embodiments of communication may be an Ethernet network, a proprietary network, a Public Switched Telephone Network (PSTN), a Wireless Application Protocol (WAP) network, or an Internet Protocol (IP) network such as the Internet, an intranet or an extranet. Moreover, as used herein, communications include those enabled by wired or wireless technology.

It should be understood that the described embodiments of the invention do not necessarily represent the full scope of features and may be enhanced or modified to improve on the stated claims of the present invention.

### DRAWINGS

CheckSplit_FIG1: A high-level work flow diagram of the preferred embodiment of the present system within a restaurant.

CheckSplit_FIG2: A process flow diagram of the preferred embodiment of the present system.

The attached diagrams only describe one embodiment of the system and do not represent the entire scope of the present invention.

1: A method for cellular phones, personal computing devices and other mobile devices, available to the general consumer, to communicate with multiple data sources, whereby order details for each patron can be obtained for an outstanding bill at a restaurant.

2: A method of displaying a detailed list of all menu items ordered by each patron, whereby the order details are obtained from a separate data source than that of the present invention, thus allowing compatibility with multiple order management and point of sale systems.

3: A method of calculating custom payment amounts for each patron, whereby one or more components of the outstanding bill can be mathematically combined and or divided based on instructions by the user/operator.
